(19) United States
(12) Patent Application Publication
(10) Pub. No.: US 2021/0134537 A1
(43) Pub. Date: May 6, 2021

(54) AN ELECTRODE AND AN ELECTROCHEMICAL CAPACITOR COMPRISING THE ELECTRODE

(71) Applicant: B.G. NEGEV TECHNOLOGIES AND APPLICATIONS LTD., AT BEN-GURION UNIVERSITY, Beer-Sheva (IL)

(72) Inventors: Raz JELINEK, Modi'in-Maccabim-Reut (IL); Ahiud MORAG, Nes-Ziona (IL)

(73) Assignee: B.G. NEGEV TECHNOLOGIES AND APPLICATIONS LTD., AT BEN-GURION UNIVERSITY, Beer-Sheva (IL)

(21) Appl. No.: 16/482,525

(22) PCT Filed: Feb. 20, 2018
(86) PCT No.: PCT/IL2018/050189

§ 371 Date: Jul. 31, 2019

Related U.S. Application Data
(60) Provisional application No. 62/465,175, filed on Mar. 1, 2017.

(51) Int. Cl. H01G 11/46; H01G 11/86; H01G 11/36

(52) U.S. Cl. CPC H01G 11/46; H01G 11/36; H01G 11/86

(57) ABSTRACT

An electrode including a base and a coating deposited on the base, where the base includes nanostructures made of a metal (e.g., gold) and reduced graphene oxide, and the coating includes pseudo-capacitor material (e.g., MnO2). A process of fabricating the electrode and an electrochemical capacitor including the electrode is also provided.

Electrochemical capacitors are used as energy storage and power supply devices in many applications, i.e., in the microelectronic industry. They fall into the following categories: electric double layer capacitors (where energy is stored electrostatically, that is, electrostatic double-layer capacitance that depends on the surface area of the electrodes), pseudocapacitors (where energy is stored electrochemically) and hybrid type (where energy is stored both ways).

Electrode materials employed in the fabrication of electric double layer capacitors are high surface area carbon-based materials. As to pseudocapacitors, transition metal compounds, e.g., oxides such as MnO₂, RuO₂, V₂O₅, Co₃O₄ and TiO₂ are utilized as electrode materials, and also electrically conducting polymers. Hereinafter, the term “pseudocapacitor material” is meant to include both types (transition metal compounds and electrically conducting polymers).

The fabrication of pseudocapacitors requires the aforementioned materials, e.g., the transition metal oxides, to be applied on a conductive, high-surface area electrode. For example, U.S. Pat. No. 9,406,449 demonstrates the growth of TiO₂ and MnO₂ on graphene or glassy carbon substrate using atomic layer deposition technique. The same method was also reported in WO 2015/112628 to generate RuO₂ films onto carbon nanotubes. The preparation of MnO₂/carbon nanofiber composite for electrodes of electrochemical capacitors is described in WO 2015/023193. Ghosh et al. [Advanced Functional Materials, 21, p. 2541-2547 (2011)] reported the deposition of V₂O₅ on polyacrylonitrile-based carbon-nanofiber paper.

Composites consisting of reduced graphene oxide (rGO) and metals are described in WO 2012/028964. rGO was produced by treating graphene oxide with hydrazine. Next, the metal is incorporated into the resulting rGO. To this end, the rGO is combined in an aqueous solution with a metal precursor, e.g., AgNO₃, H₂PtCl₆, PdCl₂, HAuCl₄ or KMnO₄. It is reported that the inherent reducing properties of rGO enable the conversion of the metal ion into the elemental form. The so-formed composites are proposed chiefly as absorbent materials, with other utilities being briefly mentioned, e.g., for supercapacitors.

The present invention provides a fabrication method of a self-standing base substrate which is able to support the deposition of a transition metal oxide layer thereon, to create an electrode suitable for use in pseudocapacitors, as well as functioning as the current collector. The fabrication method involves the embedment of rGO in a metal nanostructure, e.g., in gold-made nanostructure, to afford a self-standing substrate with greatly improved mechanical strength, followed by the deposition of MnO₂ or other useful pseudocapacitor electrode material. One approach for achieving the incorporation of rGO in a metal nanostructure is based on improving our previous work on gold nanostructures. We previously showed—see Chem. Commun. 49, p. 8552-8554 (2013) and co-assigned patent application WO 2014/072969—that metallic gold (Au⁰) is self-assembled to form nanowires when allowed to slowly crystallize from a solution of gold thiocyanate complex dissolved in a mixture of an organic solvent and water. Plasma reduction was employed to create conductive films consisting of the gold nanowires. We have now found that the addition of graphene oxide to a solution of the aforementioned gold complex in a solvent, followed by solvent removal and reduction, leads to the formation of a nanostructure consisting of the metal in its elemental form, with rGO embedded in the nanostructure. The resulting composite exhibits good mechanical strength, high surface area and good conductivity, and can be used as a substrate for deposition of transition metal oxide thereon.

The carbon/oxygen ratio measured in graphene oxide is typically from 4:1 to 2:1. Reduced graphene oxide is obtained from graphene oxide upon reduction. In reduced graphene oxide higher carbon/oxygen ratio is measured, e.g., not less than 10:1, for example, not less than 12:1 (measurable by Auger spectroscopy or X-ray photoelectron spectroscopy (XPS)). Unlike its precursor, reduced graphene oxide is an water-insoluble material exhibiting electrical conductivity.

The term “nanostructure” is understood to be a structure that is characterized by at least one dimensional feature (e.g., thickness, height, length and the like) being in the nanometer scale, e.g., between 1 and 1000 nanometers or between 5 and 500 nanometers, more specifically from 100 to 500 nm.

Accordingly, one aspect of the invention is an electrode comprising a base and a coating deposited on said base, wherein the base comprises nanostructures made of a metal and reduced graphene oxide, especially gold and reduced graphene oxide, and the coating comprises pseudocapacitor material (e.g., a transition metal oxide).

Raman spectroscopy can be used to characterize the base of the electrode, verifying the existence of rGO by measuring the relative intensity of the characteristic D and G peaks (located at about 1350 cm⁻¹ and 1600 cm⁻¹, respectively), e.g., the relative intensity of the peaks (ID/IG) is not less than 1.1, e.g., not less than 1.2 (measured as the ratio between the corresponding maxima—highest intensity points—of these fairly broad peaks). More specifically, the base is essentially devoid of graphene oxide.

The preferred base which is used to support the transition metal oxide coating in the electrode of the invention consists of reduced graphene oxide-added gold. The metal (e.g., gold) constitutes the major component of the base. That is, the weight ratio between the metal and the rGO is in the range from 4:1 to 10:1, for example, from 5:1 to 6:1. The thickness of the base is in the range from 100 to 200 microns. The metal (e.g., gold) nanostructures form a network, i.e., are interlaced or interconnected with other nearby nanostructures, with the rGO covering portions of these nanostructures, as indicated by scanning electron microscopy (SEM) analysis.

Another aspect of the invention is a process of fabrication of an electrode, comprising assembling a metal compound and graphene oxide to nanostructures, subjecting said nanostructures to reductive conditions to convert the metal into its elemental form and the graphene oxide into reduced graphene oxide, recovering a film composed of a bundle of elemental metal nanostructures and reduced graphene oxide, and depositing pseudocapacitor material onto the surface of said film.

Another aspect of the invention is the use of rGO-added metal film as support for pseudocapacitor material, in particular transition metal oxide such as MnO₂.

A key feature of the invention resides in the ability to create a solid consisting of (i) a metal compound in the form of nanostructures arranged in a network, in particular >100 μm long wires, that is, preferably >200 μm long wires, e.g., from 200 to 300 μm with diameter ranging from 100 to 500 nm, and (ii) graphene oxide sheets distributed throughout the network. The experimental work reported below indicates that the network structure could be successfully obtained upon mixing a suitable metal compound such as gold thiocyanate complex and graphene oxide in a solvent, following which the solvent is removed to form a reducible thin film.

Regarding the gold thiocyanate complex used as a starting material, it should be noted that oxidation states of gold in the two thiocyanate complexes are 3+ and 1+, respectively. In certain conditions, e.g. in aqueous solutions, [Au(SCN)₄]¹⁻ may spontaneously convert into [Au(SCN)₂]¹⁻. Hereinafter, the term “gold thiocyanate complex” is used to indicate either auric complex, aurous complex or a mixture thereof. The complex is preferably prepared as follows. An auric compound, for example hydrogen aurichloride (or a salt of said acid with a base, e.g., sodium aurichloride), is added to an aqueous solution of thiocyanate salt, especially the potassium salt which is the most stable of the alkali thiocyanates. The reactants are preferably used in stoichiometric quantities. The reaction, which generally takes place at room temperature, results in the instantaneous precipitation of a salt of the formula MAu(SCN)₄, wherein M indicates an alkali metal, preferably potassium. It should be noted that KAu(SCN)₄ is sparingly soluble in water at room temperature, and is separable from the mother liquor by conventional methods such as filtration or centrifugation.

Regarding the graphene oxide used as a starting material, it is readily obtainable by methods known in the art, in particular, the Hummers' method, where oxidation of graphite flakes or powder takes place upon adding the graphite to a cold solution of sulfuric acid (e.g., 0° C.) followed by gradual addition of sodium nitrate and potassium permanganate under continuous stirring. For example, on a laboratory scale, the addition time of each of the successively added NaNO₃ and KMNO₄ reagents is not less than ten to fifteen minutes. On completion of reagent's addition, the reaction mixture is heated to about 35-45° C. and kept under stirring for a couple of hours, e.g., not less than two hours. The reaction is terminated by addition of water and hydrogen peroxide which removes excess permanganate. The graphene oxide is recovered by centrifugation and freeze drying.

For use in the present invention, as-prepared graphene oxide is dissolved in a suitable organic solvent, e.g., polar-aprotic organic solvent or an aqueous mixture thereof, preferably one selected from the group consisting of acetonitrile/water mixture, dimethyl sulfoxide (DMSO), N,N-dimethylformamide (DMF), N-methyl-2-pyrrolidone (NMP) and tetrahydrofuran (THF). Dissolution is aided by sonication. For example, graphene oxide concentration in the solution/dispersion is from 10 mg mL⁻¹ to 20 mg mL⁻¹.

Next, the source of [Au(SCN)₄]¹⁻ {e.g., KAu(SCN)₄)} and the graphene oxide are combined, that is, [Au(SCN)₄]¹⁻ source is added to the graphene oxide solution/dispersion in the organic solvent or in a mixture of the organic solvent and water. The dissolution of the MAu(SCN)₄ is generally achieved at temperature in the range from 0 to 30° C. The concentration of the complex salt in the solution may be from 10 mg mL⁻¹ to 15 mg mL⁻¹.

Assembly of the gold complex and graphene oxide (GO) to form nanostructures (e.g., cylindrical bodies with length/diameter ratio of preferably not less than 250:1) takes place when the aforementioned GO/[Au(SCN)₄]¹⁻ solution is applied onto a suitable surface (glass for example) to permit slow solvent removal and creation of a thin film. By slow evaporation of the solvent is meant, for example, evaporation rate of 1 mL per 12 h. Solvent removal is achieved at a temperature in the range from 0 to 30° C.

Hence, a specific variant of the invention is a process wherein the step of assembling the metal compound and graphene oxide to nanostructures comprises:
combining gold thiocyanate complex and graphene oxide in an organic solvent or in a mixture of an organic solvent and water, applying the-so formed solution onto a surface; and
slowly removing the solvent to create a thin film consisting of gold nanostructures in the form of wires coated with graphene oxide.

Scanning electron microscopy (SEM) can be used to study the morphology of the dry, non-reduced film. SEM images show a network structure consisting of individual wires exhibiting uniform, smooth appearance with diameter for example of about 20 μm and length of up to several hundred microns. The wires are partially coated with graphene oxide.

The next steps of the process involve the reduction of the reducible components of the film, that is, Au⁺ ion (p=1, 3; preferably 3) to Au⁰, transforming the nanowires into an essentially metallic form, and graphene oxide into reduced graphene oxide. Preferably, plasma reduction is employed for gold formation. The substrate-supported film is placed in a plasma chamber, e.g., in a commercially available plasma instrument used for cleaning. The plasma chamber is connected to a vacuum pump, and plasma is generated at pressure of 0.1-1 Torr by using radio frequency (RF) power supply operating at 85 W for not less than 10 minutes, effectively reducing Au^{p+} to Au⁰. The step of plasma reduction may be repeated several times; sample is washed in water and dried between each reduction step.

X-ray diffraction analysis indicates the effectiveness of plasma reduction in forming elemental gold. The XRD exhibits peaks assigned to Au⁰ (e.g., at 38 and 44 2θ positions), and is devoid of diffraction lines characteristic of Au³⁺ species. X-ray photoelectron spectroscopy (XPS) also reveals that following the plasma reduction, the wires contain gold in metallic form. The X-ray photoelectron spectrum displays peaks at binding energies of 83±1 and 87±1 assigned to Au₍ₘₑₜₐₗ₎ 4f(7/2, 5/2) photoelectrons, respectively.

Though effective for Au³⁺ reduction to produce Au⁰, plasma treatment can only partially reduce graphene oxide. Complete reduction of graphene oxide is achievable by chemical reduction, that is, with the aid of chemical reducing agents, such as hydrazine. To this end, the Au⁰/GO composite is placed in a suitable chamber where it is treated with hydrazine in the vapour phase. But other reducing agents may also be effective, for example, sodium borohydride, provided that they do not attack the gold. Other methods for reducing GO include thermal heating or microwave irradiation, again under the condition that the gold is not damaged.

Hence, a specific variant of the invention is a process wherein the step of subjecting the graphene oxide-coated gold wires to reductive conditions comprises:
reducing gold ions into Au⁰ with the aid of plasma reduction; and
reducing the graphene oxide into reduced graphene oxide with the aid of a reducing agent;
thereby obtaining a film composed of a bundle of elemental gold nanostructures coated with reduced graphene oxide.

The so-formed Au⁰/rGO film composite possesses good conductivity (e.g., about to 10³ to 10⁴ S cm⁻¹), high porosity and large active surface area. It should be noted that the added rGO imparts mechanical strength to the gold film; the film is turned into a self-standing electrode which can be used as a base substrate for supporting transition metal oxide such as MnO₂, NiO₂, RuO₂, Co₃O₄ and V₂O₅. These transitions metal oxides are all useful on account of their capacitive properties; they can be electrochemically deposited onto the Au⁰/rGO base from suitable electrolyte solution utilizing a triple-electrode set-up consisting of the Au⁰/GO as the working electrode; a counter electrode which is preferably made of platinum and a conventional reference electrode (e.g., Ag/AgCl type).

In case of MnO₂ deposition, the electrolyte contains Mn²⁺ ions, for example, manganese acetate solution (e.g., with Mn²⁺ concentration ranging from 0.05 to 0.5M) in the presence of a supporting electrolyte such as sodium sulphate (0.05-0.5M Na₂SO₄). Another useful electrolyte solution consists of MnSO₄ solution with added acetate salts, as proposed by Broughton et al. See: https://www.electrochem.org/dl/ma/206/pdfs/1530.pdf. Electrochemical deposition of MnO₂ could be accomplished with the aid of (i) potentiostatic method, at a constant potential set in the range between 0.5 and 3V; (ii) galvanostatic method, with constant current density set in the range from 1 to 5 mA cm⁻², or by (iii) cyclic voltammetric method.

It should be noted that instead of electrochemical deposition, other methods can be used for coating the Au⁰/rGO composite with transition metal oxide, for example, atomic layer deposition, as described, for example, in US 2014/0340818.

Formation of the transition metal oxide coating may be determined using X-ray photoelectron spectroscopy. The thickness of the transition metal oxide coating is in the range of tens of nm to several microns. Surface morphology of the transition metal oxide-coated electrodes is investigated with the aid of scanning electron microscopy. SEM images indicate the uniformity of the coating, showing, for example, that electrochemically-deposited MnO₂ particles exhibit flower-like morphology. This favorable morphology increases the overall surface area as compared to other (e.g., plate) morphologies.

Accordingly, the process of the invention most preferably comprises a step of electrochemically depositing MnO₂ onto the surface of a film composed of a bundle of elemental gold nanostructures and reduced graphene oxide.

It should be noted that the coating layer is generally a homogeneous layer consisting of a single material. But in some variants of the invention multiple layers made of different materials are successively applied onto the base. For example, the coating may consist of a pseudocapacitive material such as the above-mentioned transition metal oxides on top of electrically conductive layer applied directly onto the base.

The performance of the electrodes of the invention was evaluated with the aid of cyclic voltammetry based on a conventional three electrode set-up, to generate plots of current measured against the scanned potential range to determine the capacitance of the electrodes. In addition, the capacitance was measured with galvanostatic charge-discharge applying constant current density and measuring the potential as function of time.

Total areal capacitance and outer surface areal capacitance calculated on the basis of cyclic voltammetry for the electrodes of the invention exceed 3500 mF cm⁻² and 2500 mF cm⁻², indicating that the electrodes of the invention exhibit fairly high (above 60%) ratio between the total areal capacitance and the outer surface capacitance. Still, at the same time the high total capacitance makes the electrode of the invention especially suitable for applications requiring high energy and not high power.

A pair of electrodes was assembled to form a simple symmetric electrochemical capacitor which was then tested using a two-electrode set-up, to determine properties such as galvanostatic charge-discharge curves and cycle stability. The experimental results reported below indicate that the electrochemical capacitor of the invention possesses good cycle durability, seeing that it operates effectively for more than 1000 cycles with an acceptable decline in performance. The charge-discharge curves of the fully assembled electrochemical capacitor are fairly linear; the curves were used to calculate the resistance of the symmetric electrochemical capacitor and other significant properties such as power and energy densities. The results indicate the good performance of the symmetric electrochemical capacitor. It should be understood, however, that the electrode of the invention may be sued to fabricate an unsymmetrical capacitor as well.

Accordingly, another aspect of the invention is an electrochemical capacitor comprising a pair of spaced apart electrodes, a separator between said electrodes and an electrolyte disposed in the space between said electrodes and in contact therewith, wherein at least one of said electrodes has a base and a transition metal oxide coating deposited on said base, wherein the base consists of nanostructures comprising metal (e.g., gold) and reduced graphene oxide, as described above.

The space between the electrodes is impregnated with an electrolyte. Different types of electrolytes may be used, that is, an aqueous electrolyte (e.g., sulfuric acid, potassium hydroxide KOH, alkali chlorides such as lithium and potassium chloride), organic electrolyte and ionic liquids.

The separator of choice meets requirements such as nonconductivity, chemical resistance to electrolytes, mechanical resistance and good wettability. Cellulose paper and polymer-based separators (possessing either fibrous structure or consisting of monolithic networks with pores) may be used.

Possible designs of electrochemical capacitors, fabrication methods (including the stacking of multiple cells and bipolar arrangements) and applications thereof are known in the art and are described, for example, in “Electrochemical Supercapacitors for Energy Storage and Conversion (Kim et al.; Handbook of Clean Energy Systems published by John Wiley & Sons (2015)]. That is, several capacitors are often combined in serial and parallel circuits, depending on whether higher voltage or higher power is needed. Owing to the fact that the Au/rGO base of the invention serves as an efficient current collector for the electrode, the incorporation of a separate current collector is not essential, such that a plurality of individual capacitors (each consisting of a pair of spaced apart electrodes) may be stacked in parallel configuration to produce low volume and low weight “vertical” capacitor. The capacitors may be produced as distinct units which are brought together according to the desired design, or may be assembled as a system at the time of manufacture. On account of their ability to be charged and discharged rapidly, the capacitors of the invention can be integrated in many applications, to store energy which could be quickly delivered, for example, for quick charging in mobile or other electronic devices and camera flashes. The capacitors may be coupled to batteries or potentially replace batteries.

### EXAMPLES

### Materials

All reagents were used as received without further purification. Chloroauric acid trihydrate (HAuCl₄*3H₂O) and potassium thiocyanate (KSCN) were purchased from Sigma Aldrich. Sodium nitrate, potassium permanganate, lithium chloride, manganese acetate, lithium sulfate and sodium sulfate were purchased from Alfa Aesar. Acetonitrile was purchased from Bio-Lab Ltd (Jerusalem, Israel).

Water used in the experiments were doubly purified by a Branstead D7382 water purification system (Branstead Thermolyne, Dubuque, Iowa), at 18.3 MΩ resistivity.

### Methods

Scanning electron microscopy (SEM): SEM images were acquired using JEOL JSM-7400F Scanning Electron Microscope (JEOL LTD, Tokyo, Japan).

Powder x-ray diffraction (XRD): XRD patterns were obtained using Panalytical Empyrean Powder Diffractometer equipped with a parabolic mirror on incident beam providing quasi-monochromatic Cu Kα radiation (λ=1.54059 Å) and X′Celerator linear detector. Data were collected in the grazing geometry with constant incident beam angle equal to 1° in a 2θ range of 10-60° with a step equal to 0.05°.

X-ray photoelectron spectroscopy (XPS): XPS analysis was carried out using Thermo Fisher ESCALAB 250 instrument with a basic pressure of 2·10⁻⁹ mbar. The samples were irradiated in 2 different areas using monochromatic Al Kα, 1486.6 eV X-rays, using a beam size of 500 μm. The high energy resolution measurements were performed with pass energy of 20 eV.

Cyclic voltammetry (CV) and galvanostatic studies: measurements were performed on a BioLogic SP-200 instrument, in a 3-electrode configuration. Au⁰/rGO or MnO₂-coated Au⁰/rGO was used as the working electrode, platinum wire as counter electrode and Ag/AgCl as reference electrode. The measurements were conducted in a 1 M lithium chloride (LiCl) electrolyte solution at different scan rates and current densities. Device performance was conducted in a 2 electrode configuration, in which the reference electrode was connected to the counter electrode.

The capacitance from the CV experiments was calculated using the following equation:

$$C = \frac{\int I ( V ) dV}{2 \cdot A \cdot Δ V \cdot v}$$

wherein the integral of I over V is the area of the CV curve, A is the area of the electrode, ΔV is the operating potential window and ν is the scan rate.

For the galvanostatic discharging curves the capacitance was calculated using the following equation:

$$C = \frac{I \cdot Δ t}{A Δ V}$$

wherein I is the discharge current, Δt is the discharge time, A is the area of the electrode and ΔV is the operating potential window.

The energy density was calculated using the following equation:

E=½C·ΔV²

wherein C is the areal capacitance and ΔV is the operating potential window.

Power density and theoretical maximum power density were calculated using the following equations:

$$P = \frac{E}{Δ t} ;$$

$${P}_{ma x} = \frac{Δ {V}^{2}}{4 \cdot R}$$

wherein ΔV is the operating potential window and R is the resistance calculated from the IR drop in galvanostatic charge/discharge curves.

### Preparation 1

### Synthesis of Graphene Oxide

Graphite oxide was synthesized as generally described by Hummers (Preparation of Graphitic Oxide, J. Am. Chem. Soc, 80, 1958, 1339). A round bottom flask containing 46 mL of sulfuric acid, 96% weight, was cooled in an ice bath, thereafter 1 g of graphite flakes were added. The mixture was then stirred with a magnetic stirrer for 1 hour to disperse the graphite. The reaction vessel was then transferred onto a water bath, and 1 g of sodium nitrate (NaNO₃) and 6 g of potassium permanganate (KMnO₄) were successively added over 15 minutes. The temperature of the water bath was increased to 40° C. and the reaction mixture was stirred for additional 3 hours. Deionized water, 50 mL, was then slowly added to the reaction mixture, followed by mL of hydrogen peroxide, 30% weight (H₂O₂). Stirring was continued for further 10 min. The reaction mixture was then centrifuged (5000 rpm, 20 min) to separate the precipitate. Centrifugation was repeated until the supernatant showed a neutral pH. The Resulting brown colored residue was freeze-dried in lyophilizer and stored at 4° C. until use.

### Preparation 2

### Synthesis of Gold Potassium Thiocyanate (KAu(SCN)₄ Complex)

Aqueous solution of chloroauric acid (HAuCl₄*3H₂O), 20 mg*mL⁻¹, 1 mL (0.051 mmoles), was mixed with 1 mL of potassium thiocyanate (KSCN) solution, 24 mg*mL⁻¹ (0.247 mmoles). The resulting precipitate was separated by centrifugation at 4000 g for 20 min, and dried at ambient conditions.

### Example 1

### Preparation and Characterization of Au⁰/rGO-Composite

### Step 1

The product of preparation 1, 125 mg, was dispersed in 5 mL of water/acetonitrile mixture (3:5 volume ratio), and sonicated for 1 hour at 30 kHz apparatus with 320 W maximum output, to furnish a 15.6 mg*mL⁻¹ GO solution. Thereafter 12 mg of gold potassium thiocyanate (KAu(SCN)₄) was sonicated in 80 μL of the GO solution at ice bath, until the solution became homogeneous. The cooled mixture was cast on a 0.5 cm×2 cm glass support and left to dry at 4° C.

### Step 2

After solvent evaporation the glass-deposited samples (average weight 13.25 mg) were exposed to air plasma at a pressure of 0.7 mbar and power of 85 W, for 10 min. The specimens were then immersed in water for 5 seconds and left to dry for 2 hours at room temperature. The air plasma treatment was repeated two more times with washing step between them. The specimens were detachable from the glass support.

### Step 3

The samples were incubated overnight in a 500-mL chamber containing 0.4 mL of hydrazine in a vial, at 90° C., for reduction of the GO into reduced graphene oxide (rGO). Final weight of the samples was 5.8 mg.

The samples were analyzed using X-ray photoelectron spectroscopy (XPS), Raman spectroscopy, X-ray diffraction and scanning electron microscopy, at various stages of the preparation.

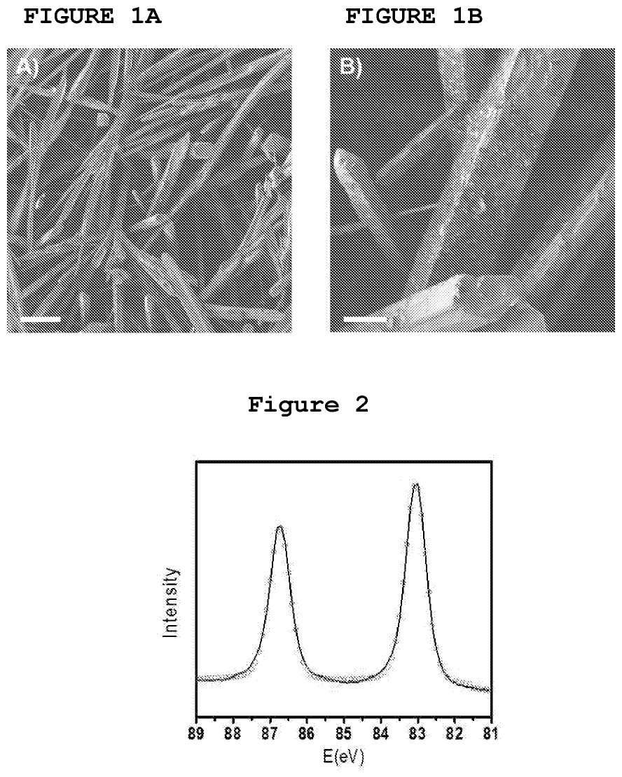

Scanning electron micrograph of the product after step 1 (that is, after solvent evaporation) is demonstrated in FIGS. 1A and 1B. Gold potassium thiocyanate in the form of microwires, partially coated with graphene oxide is seen, both at ×300 magnification (FIG. 1A) and particularly at ×1000 magnification (FIG. 1B—dark areas indicate GO).

X-ray photoelectron spectrum of the reduced composite upon completion of the step 2 (plasma reduction) is demonstrated in the FIG. 2. The 4f_{5/2} and 4f_{7/2} peaks are assigned to metallic gold.

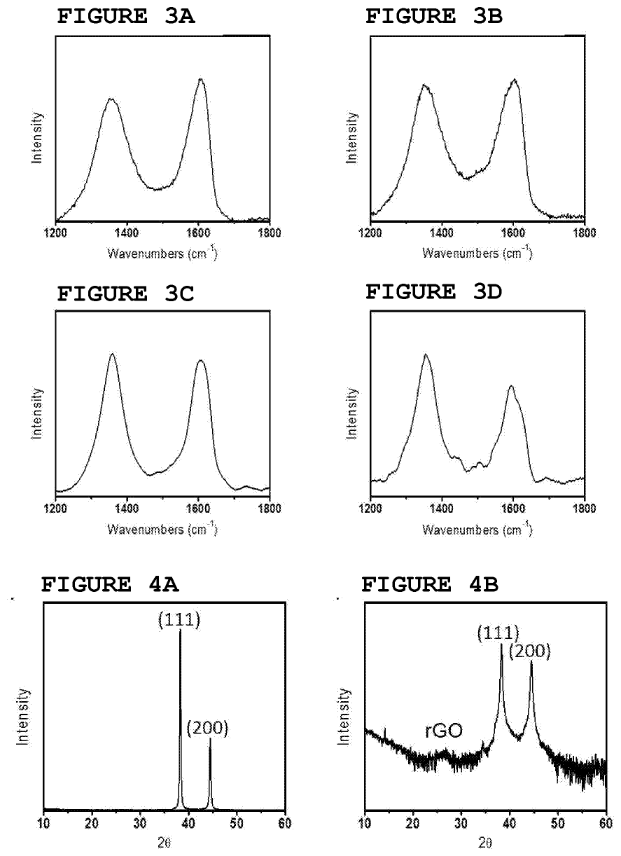

Raman spectra of the products after various steps are shown in the FIGS. 3A-3D. FIG. 3A shows the G and D bands of Raman spectrum of freshly prepared graphene oxide, whereas FIG. 3B demonstrates the bands after completion of the step 1, that is, the deposited Au complex/GO. It can be readily seen that the G peak (around 1600 cm⁻¹) is more intense then the D peak (around 1350 cm⁻¹), which is common in intact GO. FIG. 3C shows the G and D bands after completion of the step 2, that is, after plasma reduction, which caused also GO reduction to some extent. But complete reduction of GO was only achieved with the aid of hydrazine (see step 3), as shown by FIG. 3D, which clearly demonstrates the predominance of the D band over the G band, indicating the formation of rGO.

X-ray diffractograms of the composites are shown in the FIGS. 4A and 4B. FIG. 4A is X-ray diffraction recorded after plasma reduction (step 2). The peaks at about ˜38 2θ and ˜44 2θ are assigned to the (111) and (200) crystal planes of metallic gold, indicating successful conversion of Au³⁺ into Au(⁰). FIG. 4B (a log-scale diffractogram) was generated after hydrazine reduction (step 3). The peak at 25° 2θ is assigned to rGO.

### Example 2

### Preparation and Characterization an Electrode Obtained by Electrochemical Deposition of MnO₂ on Au⁰/rGO-Composite

The Au⁰/rGO composite of Example 1, having weight of 5.8 mg cm⁻², was immersed in a solution of 0.5 M manganese acetate (Mn(CH₃COO)₂) and 0.5 M of sodium sulfate (Na₂SO₄), and the deposition was performed via electrochemical oxidation of manganese acetate in a 3-electrode configuration, where Au⁰/rGO electrode was the working electrode, platinum wire was the counter electrode, and Ag/AgCl was a reference electrode. The deposition of MnO₂ was accomplished by repeatedly setting the voltage to 3V for a period of ten seconds and then switching to 0V for ten seconds (during the 0V intermission the precursor diffuses to inner layers of the electrode). The effect of deposition times was also investigated, with total deposition times varying in the range from 4 to 16 minutes. The area of the electrodes produced was 0.3-0.5 cm². The final weights of the specimens were 25-35 mg cm⁻².

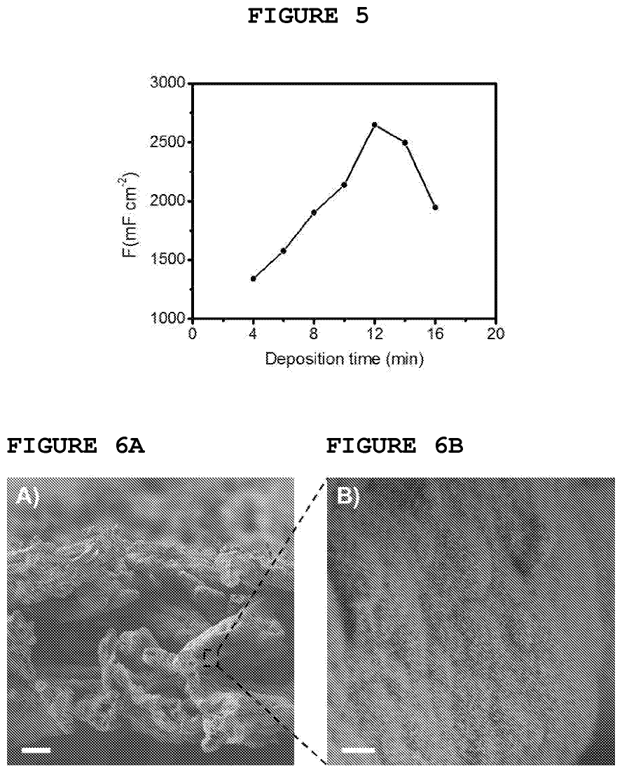

In the graph shown in FIG. 5, the capacitance of the electrodes produced is plotted against electrochemical deposition time of the MnO₂ coating (capacitance was calculated from cyclic voltammetry as described above, at a scan rate of 1 mV s⁻¹; the ΔV range was 0-0.8V). MnO₂-coated electrode obtained after twelve minutes of electrochemical deposition of MnO₂ has emerged as the best electrode and therefore for further studies reported below, samples were produced with electrochemical deposition time period of twelve minutes.

The morphology of the MnO₂-coated electrodes was examined by scanning electron microscopy. The images shown in FIGS. 6A and 6B (low magnification scale bar 20 μm and high magnification scale bar respectively) indicate that uniform MnO₂ coating was created.

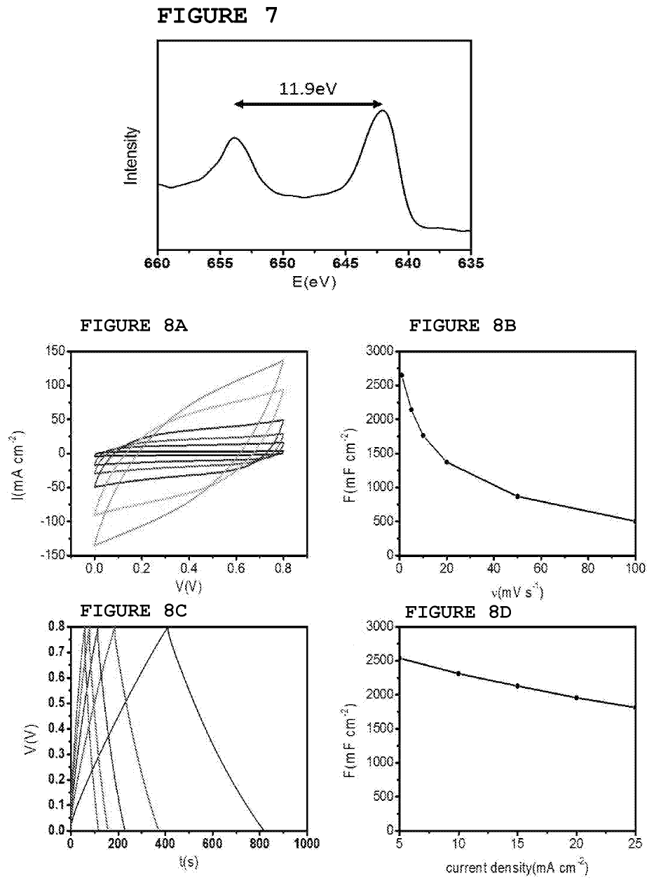

The X-ray photoelectron spectrum of the same MnO₂-coated electrode (that is, twelve minutes of electrochemical deposition of MnO₂) is presented in FIG. 7. The spectrum features two peaks of 2p_{3/2} and 2p_{1/2} with a difference in binding energy of 11.9 eV, indicative of MnO₂.

Electrochemical behavior of the MnO₂-coated electrode was investigated by cyclic voltammetry in voltage range from 0.0 to 0.8V against Ag/AgCl electrode in a 1 M lithium chloride solution; scan rates were 1, 5, 10, 20, 50 and 100 mV/s and by galvanostate charge/discharge at different current densities of 5, 10, 15, 20 and 25 mA cm⁻².

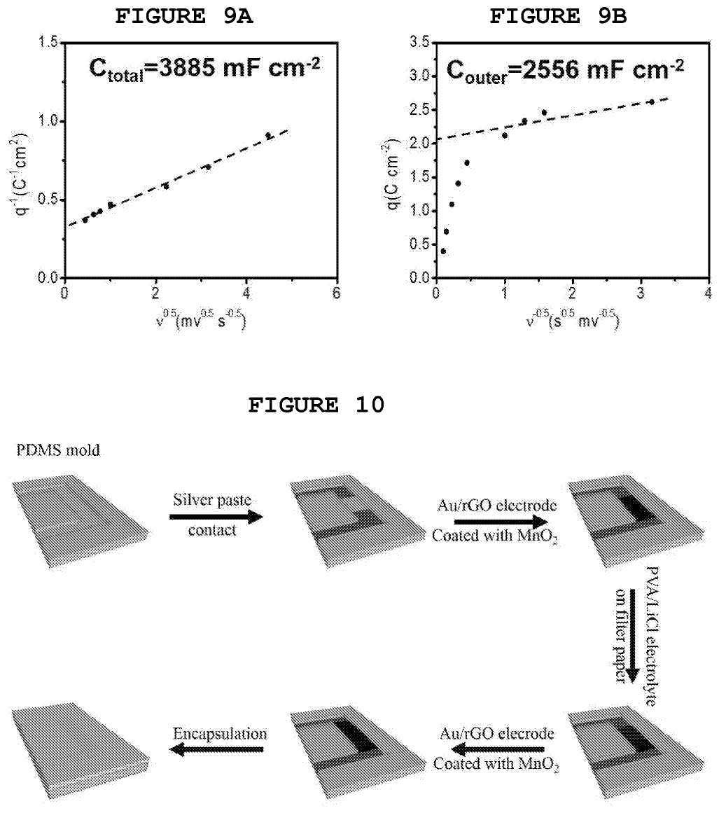

The results of cyclic voltammetry are shown in FIGS. 8A and 8B. The semi rectangular shape of the curves clearly indicates the pseudocapacitive behavior of the electrode. The outer and total areal capacitance of the electrode was calculated from the calculated charge and the scan rate data. From extrapolating the curve of q⁻¹(charge) as a function of the scanning rate (v) square root (FIG. 9A), to v=0, we can calculate the total areal capacitance of the electrode to be 3885 mF cm⁻². The outer surface areal capacitance was calculated, from extrapolation the curve of q as function of v^{-0.5} (FIG. 9B), to be 2556 mF cm⁻². The ratio between the total areal capacitance and the outer surface capacitance is hence 66%.

The results of galvanostate charge/discharge studies are shown in FIGS. 8C and 8D. The linearity of the charge/discharge curves at current densities ranging from 5 to 25 mA cm⁻² indicates that the performance of the electrode is close to ideal supercapacitance. The calculated capacitance from the galvanostate discharge curves is presented in FIG. 8D. A capacitance of 2540 mF cm⁻² for a current density of 5 mA cm⁻² is quite high. The capacitance decreases with increasing current density but still a fairly high capacity is preserved (71% at 25 mA cm⁻² compared to 5 mA cm⁻²).

### Example 3

### Preparation and Characterization of Symmetric Pseudocapacitor Device Comprising a Pair of MnO₂-Coated Electrodes

The fabrication of the device is illustrated in FIG. 10. a π-shaped polydimethylsiloxane (PDMS) stamp was used. Silver paste was spread in the two arms of the π-shaped mold and partially within the horizontal section, to provide conductive electric contacts, which are separated by a distance of about 1 cm. Then a first MnO₂-coated electrode (12 minutes MnO₂ deposition time; the overall electrode area is 0.5 cm×2 cm, where 0.5 cm×0.8 cm is covered with MnO₂), was placed in the space separating the two silver contacts, covering (2 mm) the horizontal portion of one silver contact. A filter paper soaked with an electrolyte solution (prepared by dissolving 2 g of lithium chloride and 1 g of poly(vinyl alcohol) (PVA) in 10 mL of water at 80° C. overnight) was then placed on top of the first MnO₂-coated electrode. Next, a second MnO₂-coated electrode (identical in size and shape to the first electrode) is placed on the face of filter paper and the other silver contact. The electric contacts are dried at 80° C. for 1 h after which they are covered with PDMS to prevent the electrolyte from touching them. 100 μL of the electrolyte is applied on the top electrode and left to dry and diffuse across the lower electrode for 1 h.

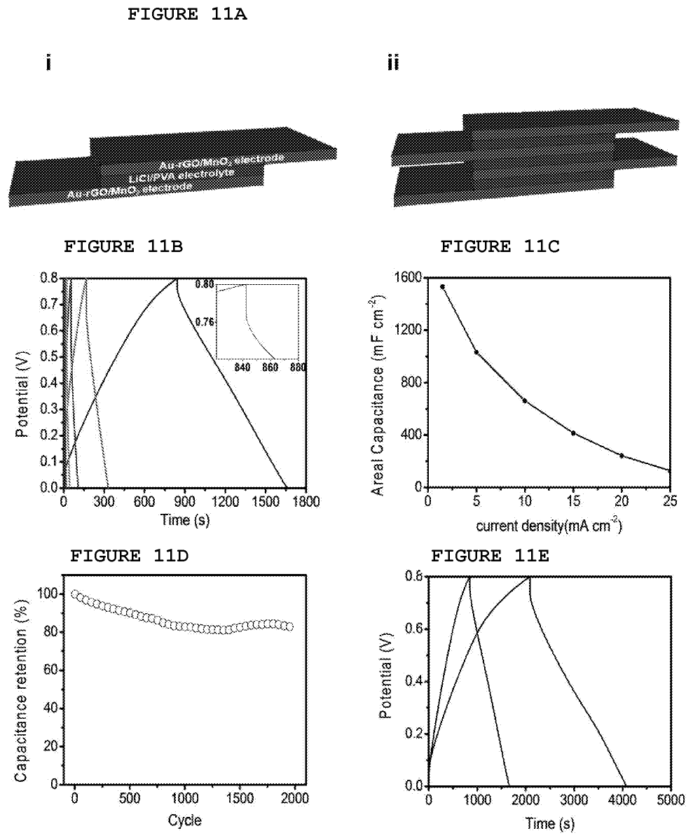

The performance of the symmetric supercapacitor was characterized using galvanostate charge/discharge. FIG. 11B depicts the galvanostate charge/discharge for current densities of 1.5 mA cm⁻² to 25 mA cm⁻². The near linearity of the curves suggests that the behavior of the device is approaching that of an ideal supercapacitor behavior. The inset in FIG. 11B shows an IR drop of 25 mV, at 1.5 mA cm⁻² current density, indicating an overall device resistance of 16.7 Ωcm⁻². From the resistance of the device we can calculate the maximum power density to be 9.58 mW cm⁻². The calculated areal capacitance of the device as a function of the current density is presented in FIG. 11C. From the calculated areal capacitance, it is seen that the for 1.5 mA cm⁻² a value of 1532 mF cm⁻² is achieved; this value gives an energy density of 0.136 mWh cm⁻². The capacitance retention was measured over 2000 cycles at a current density of 15mA cm⁻². The device was found to keep 83% of the initial capacitance showing good cycle stability (see FIG. 11D). Due to the absence of a supporting substrate and a current collector, the electrodes can be stacked to produce a parallel configuration. The performance of the different amount of electrodes stacked together can be seen in FIG. 11E (a single capacitor comprising two electrodes: left curve; a pair of stacked capacitors comprising four electrodes: right curve), where FIG. 11Aii shows schematic representation of the stacking of multiple electrodes. The calculated capacitance for the stacked configuration is 3700 mF cm⁻².

A comparison between the electrochemical performance of the preferred electrode of the invention (designated by the notation Au⁰/rGO-MnO₂, wherein Au⁰/rGO indicates the base consisting of the gold nanostructures and reduced graphene oxide, and MnO₂ stands for the manganese oxide coating layer deposited onto the base) and a prior art electrode Au-RuO₂ is set out in Table 1. The data tabulated in Table 1 is based on results reported above for the electrode of the invention and on results reported by Feris et al. [Adv. Mater. 27 (6625-6629), 2015] for Au-RuO₂ electrode.

TABLE 1

| | Specific | Specific | Specific |
|---|---|---|---|
| | capacitance | energy | power |
| | mF cm⁻² | μWh cm⁻² | mW cm⁻² |
| Au⁰/rGO-MnO₂ | 1532 at 1.5 mA cm⁻² | 136 | 9.58 |
| Au⁰—RuO₂ | 1220 at 1.5 mA cm⁻² | 126 | 7.9 |

It should be pointed out that RuO₂ has fairly high conductivity amongst the group of metal oxides and therefore electrode consisting of RuO₂ deposited onto gold is expected to perform better than an electrode consisting of MnO₂ deposited onto gold. It is seen that the self-supported MnO₂-coated gold/rGO electrode of the invention also achieves good performance.

Additionally, the specific capacitance of the individual electrode that was obtained from the three-electrode set up reported above was used to calculate the energy density and power density of a symmetrical cell consisting of two identical electrodes of the invention prepared in the Example above (assuming 1 M lithium chloride electrolyte). It is noted that the capacitance of the cell is that of the individual electrode divided by two. That is, C_{cell}=C_{areal capacitance}/4 m, where m is the weight of a single electrode (25-35 mg cm⁻²) and C_{areal capacitance} indicates the areal capacity (2539-1813 mF cm⁻²). The calculation shows that power density of 40 mW g⁻¹ can be achieved at a delivered energy density of 2.05 mWh g⁻¹. With the power density of the capacitor being increased to 100 mW g⁻¹, the energy density drops by just 20%. Hence the newly developed electrode material of the invention enables the built of electrochemical capacitors achieving both high power density and energy density.

1-15. (canceled)

16. An electrode comprising: a base and a coating deposited on said base, wherein the base comprises nanostructures made of a metal and reduced graphene oxide, and the coating comprises pseudo-capacitor material.

17. An electrode according to claim 16, wherein the base comprises nanostructures made of gold.

18. An electrode according to claim 16, wherein the metal forms a majority of the base and the reduced graphene oxide constitutes the minor component of the base.

19. An electrode according to claim 18, wherein a weight ratio between the metal and reduced graphene oxide is in the range from 4:1 to 10:1.

20. An electrode according to claim 19, wherein the metal nanostructures form a network, wherein nanostructures are interlaced or interconnected with other nearby nanostructures, with the reduced graphene oxide covering portions of said nanostructures, as indicated by scanning electron microscopy.

21. An electrode according to claim 16, wherein the base is essentially devoid of graphene oxide.

22. An electrode according to claim 16, wherein the coating comprises a transition metal oxide as the pseudo-capacitor material.

23. An electrode according to claim 22, wherein the transition metal oxide is MnO2.

24. An electrode according to claim 23, further comprising a base made of reduced graphene oxide-added gold nanostructure with MnO₂ coating deposited on said base, wherein the thickness of the base is from 100 to 200 μm.

25. A process of fabrication of an electrode, comprising: assembling a metal compound and graphene oxide to nanostructures , subjecting said nanostructures to reductive conditions to convert a metal ion in said metal compound into elemental form and the graphene oxide into reduced graphene oxide, recovering a film composed of a bundle of elemental metal nanostructures and reduced graphene oxide, and depositing pseudo-capacitor material onto the surface of said film.

26. A process according to claim 25, wherein the assembling of the metal compound and graphene oxide to nanostructures comprises:
combining gold thiocyanate complex and graphene oxide in an organic solvent or in a mixture of an organic solvent and water;
applying the-so formed solution onto a surface; and
slowly removing the solvent to create a thin film consisting of gold nanostructures in the form of wires coated with graphene oxide.

27. A process according to claim 25, wherein the subjecting of the graphene oxide-coated gold wires to reductive conditions comprises:
reducing gold ions into Au⁰ with the aid of plasma reduction; and
reducing the graphene oxide into reduced graphene oxide with the aid of a reducing agent;
thereby obtaining a film composed of a bundle of elemental gold nanostructures coated with reduced graphene oxide.

28. A process according to claim 25, wherein the depositing of pseudo-capacitor material onto the surface of the film comprises:
electrochemically depositing a transition metal oxide selected from the group consisting of MnO₂, NiO₂, RuO₂, Co₃O₄ and V₂O₅.

29. A process according to claim 28, further comprising electrochemically depositing MnO₂ onto the surface of the film composed of a bundle of elemental gold nanostructures and reduced graphene oxide.

30. An electrochemical capacitor comprising a pair of spaced apart electrodes, a separator between said electrodes and an electrolyte disposed in the space between said electrodes, wherein at least one of said electrodes is as defined in claim 16.
